(19) United States
(12) Patent Application Publication
(10) Pub. No.: US 2005/0172229 A1
(43) Pub. Date: Aug. 4, 2005

(54) Browser user-interface security application

(75) Inventors: James D. Reno, Scotts Valley, CA (US); Thomas Wu, Mountain View, CA (US); John Wang, Sunnyvale, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Arcot Systems, Inc., Sunnyvale, CA (US)

(21) Appl. No.: 11/046,207

(22) Filed: Jan. 28, 2005

Related U.S. Application Data
(60) Provisional application No. 60/540,714, filed on Jan. 29, 2004.

(51) Int. Cl. H04L 9/00

(52) U.S. Cl. 715/700

(57) ABSTRACT

A user interface through which a user at a client device interacts, via a network, with one or more resource sources includes a display window that displays resources sent to the client device from the one or more resource sources and a control area having one or more applications that allow the user to manipulate interaction with the one or more resource sources. The one or more applications include a security application that includes at least one data field for receiving input from the user to be sent to a specific resource source and an icon that provides a visual indication of whether the specific source is a trusted resource source.

### CROSS-REFERENCES TO RELATED APPLICATIONS

This application is a non-provisional of and claims the benefit of U.S. Provisional Patent Application No. 60/540,714, entitled “BROWSER USER-INTERFACE INTEGRATED SENSITIVE DATA ACCESS” filed on Jan. 29, 2004, the entire disclosure of which is herein incorporated by reference for all purposes.

### BACKGROUND OF THE INVENTION

This invention relates generally to the field of network security. More specifically, the invention relates to methods and systems for preventing users from mistakenly providing sensitive information to untrusted entities.

Fraudulent activities on the Internet have increased drastically. Examples include password spoofing, password phishing, and man-in-the-middle attacks. “Spoofing” and “phishing” generally refer to the practice by nefarious parties of fooling a web user into providing sensitive information, such as passwords, personal information, financial information, and the like, by imitating a web site the user trusts. “Man-in-the-middle attack” (MITM) generally refers to the practice of sniffing packets from a network, possibly modifying them, then returning them to the network. MITM typically requires comprising a sender's and/or a receiver's public key. In part, these fraudulent activities are successful because users are trained to enter sensitive information directly into web forms and popup windows. The content and appearance of these windows are easy to spoof since they are based on ordinary HTML. Any content delivered over the web, however, is easy to duplicate for the purposes of setting up a fake web site. In general there is risk whenever one wants to share sensitive information via a network. Thus, systems and methods are needed that assist users to not provide sensitive information to untrusted entities.

### BRIEF SUMMARY OF THE INVENTION

Embodiments of the invention thus provide a user interface through which a user at a client device interacts, via a network, with one or more resource sources. The user interface includes a display window that displays resources sent to the client device from the one or more resource sources and a control area having one or more applications that allow the user to manipulate interaction with the one or more resource sources. The one or more applications include a security application that includes at least one data field for receiving input from the user to be sent to a specific resource source and an icon that provides a visual indication of whether the specific source is a trusted resource source.

In some embodiments, the user interface may include means for interacting with a source of information relating to whether resource sources are trusted resource sources. The user interface may be a web browser. The security application may include a plug-in to the web browser. The client device may be a personal computer, personal digital assistant, laptop computer, workstation, cell phone, and/or the like. The one or more resource sources may be web sites. The at least one data field may have at least two states, a first state that accepts input if the specific resource source is a trusted resource source, and a second state that does not accept input if the specific resource source is not a trusted resource source. The security application may be a tool bar, a dialog box, a popup window, a standalone application, and/or the like. The security application may include an options menu for configuring the security application. The security application may include a selection that allows the user to declare a specific resource source to be a trusted resource source. The selection that allows the user to declare a specific resource source to be a trusted resource source may require user authentication. The security application may include a visual indication of a level of trust of a specific resource source. The visual indication may include a number from a scale, a color from a spectrum, and/or the like. The data field may includes a predetermined, user-defined personal assurance message that signals the user that the security application generated the data field. The security application may include a randomly-generated visual background.

Other embodiments provide a method of facilitating interaction between a user at a client device and a resource source. The client device includes a user interface through which the user interacts, via a network, with one or more resource sources. The method includes evaluating whether a resource directed to the client device is from a trusted resource source, displaying an icon on the client device that provides a visual indication of whether the resource is from a trusted resource source, and providing, in a control area of the client device, a data field for receiving input from the user to be sent to the resource source. The icon and data field together are a security application.

In some embodiments, the method includes receiving from a source of information an indication of whether one or more resource sources are trusted resource sources. Providing a data field may include providing the data field in a first state that accepts input if the resource source is a trusted resource source and providing the data field in a second state that does not accept input if the resource source is not a trusted resource source. The method may include providing an options menu for configuring the security application. The method may include receiving a selection from the user declaring a specific resource source to be a trusted resource source. The method also may include receiving user authentication prior to receiving the selection. The method may include providing a visual indication of a level of trust of the resource source. The visual indication may include a number from a scale, a color from a spectrum, and/or the like. The method may include providing in the data field a predetermined, user-defined personal assurance message that signals the user that the security application generated the data field. The method may include providing a randomly-generated visual background to the security application.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a network system in which embodiments of the invention may be implemented.

FIGS. 2A and 2B include a swim diagram illustrating methods of assisting users to not provide sensitive information to untrusted entities according to embodiments of the invention.

FIGS. 3A and 3B illustrate exemplary browser windows having a tool bar security application according to embodiments of the invention.

### DETAILED DESCRIPTION OF THE INVENTION

Embodiments of the invention provide network security applications. Such security applications assist network users not to provide sensitive information to untrusted entities. The security application, in some embodiments, is a consistent interface, in most cases appearing in a control region of a familiar application such as a web browser (i.e., a browser toolbar), which a user comes to trust for receiving sensitive information. In some embodiments the security application is a web browser tool bar, although in other embodiment, it may be an applet embedded in a web browser, a standalone application, or the like. The appearance of the application and whether it will accept the input depends on the trustworthiness of the network entity with which the user is communicating. Thus, although the appearance of a resource within the user's browser application may appear trustworthy, the appearance of the security application, and not the resource, provide the true indication of the source's trustworthiness to the user.

Sensitive information may include authentication data, digital identity data, personal data, and the like. For example, a user could enter a static or dynamic password to access a local credential (e.g. cryptographic key store, biometric), remote credential (e.g. cryptographic key roaming server) or even a handwritten biometric electronic signature system. In the case of biometrics, the security application, in some embodiments, provides confirmation that the user is not authenticating to a false site and thus perhaps signing data he did not intend to.

Embodiment of the invention may apply to any scenario wherein sensitive information is shared. As an example, in the context of authentication data, in addition to providing access to numerous authentication methods, embodiments of the invention may be used in a variety of systems including login at an eCommerce or home banking website, digital or electronic signature of a financial transaction, logging into a SSL VPN, etc. Other systems that utilize a browser and require authentication such as FTP server access and file access through Microsoft Explorer functionality may also apply.

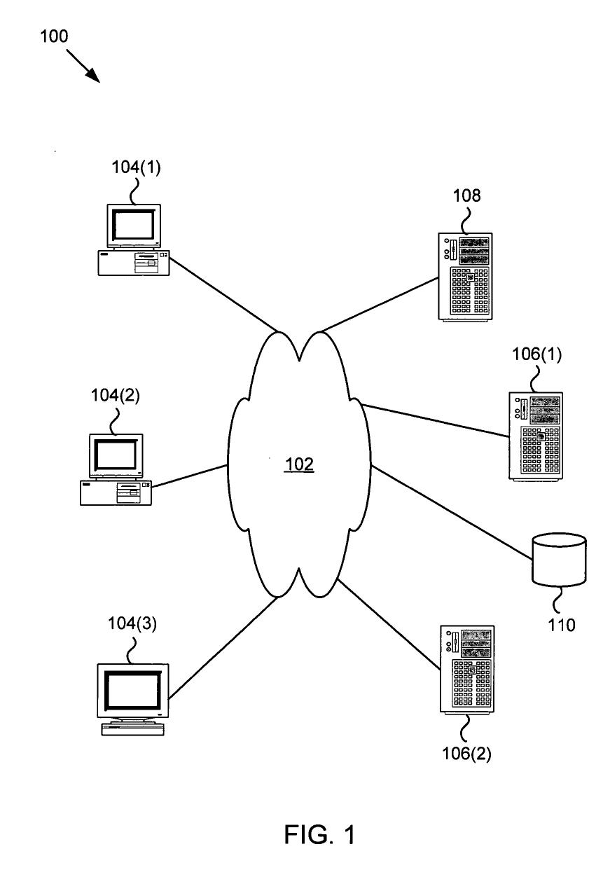

Attention is directed to FIG. 1, which illustrates a network system 100 within which embodiments of the invention may function. The system 100 includes a network 102 through which users operate user devices 104 to interact with resource sources 106, 108. The network 102 may be any network, wired or wireless, such as, for example, the Internet, an intranet, a LAN, a WAN, or any combination of the foregoing. The user devices 104, may be any computing device capable of network communication. Examples include personal computers, workstations, laptops, cell phones, personal digital assistants (PDA), and the like. A user device 104 typically includes application software that configures it for network communication. In a specific embodiment, the application software is browser software. Herein the term “browser” is to be construed broadly so as to refer to any application that allows a user to interact with resource sources via a network.

The resource sources 106, 108 may be any computing device capable of network communication, although the resource sources 106,108 typically are web servers. Examples of resource sources include servers, workstations, personal computers, and the like. Thus, resources sources 106, 108 typically “host” web sites and send and receive resources (e.g., web pages) to users. Herein the term “resource” is to be construed broadly so as to refer to any network transmission. It is also to be understood that a particular resource source may host numerous web sites (i.e., resources), some of which may be trusted and some not, as will be explained. For ease of discussion, however, the following description will refer to resource source as if it hosts only a single resource, which may be trusted or not.

Resource sources may be “trusted” such as resource sources 106, or “untrusted” such as resource source 108. A trusted source is one that has been deemed so by any of a number of processes. A source may be trusted because a particular authority has deemed the source to be trusted. A source may be trusted because a user or the user's organization has configured its systems to trust the source. Other possibilities exist and will be described in greater detail hereinafter. An untrusted resource is one that has not been deemed “trusted.”

The network system also includes a trust authority 110, or “trust information source” as it is sometimes referred to herein. The trust authority 110 collects information about resource sources and distributes the information to users. Users may send alerts to the trust authority, after which the trust authority evaluates the information that was provided and distributes relevant information as necessary. This process will be explained in more detail hereinafter.

In one example of an embodiment of the present invention in operation, a user operates web browser software on his user device 104(1) to request a resource from a source 106(1). The source 106(1) is, in this specific example, the user's bank, and the resource is the login screen that allows the user to access his online bank statement and transactions menu. The untrusted source 108 recognizes the request and, having programmed a duplicate of the source's login page, attempts to satisfy the resource request by sending this “spoof” page to the user device 104(1). If the untrusted source is successful getting his spoof page to the user device before the trusted source 106(1) gets the legitimate page to the user device, the user's display may nevertheless appear as expected, having data fields for entering the user's account number and password. This user, however, has installed the security application according to an embodiment of the invention.

As will be explained further below, the user receives a visual indication that the untrusted source, whose display screen is rendered on the user's device, does not appear on a list of trusted sources. Thus, the security application displays an icon that so alerts the user. Further, the security application includes a data field that receives the user's password and/or account number. In this instance, however, the data field(s) are “grayed out,” so that the user cannot enter the sensitive information. Thus, through a combination of operations, the security application attempts to prevent the user from divulging sensitive information to an untrusted source. Of course, the user could still enter information directly into a data field in the web page. As will be described, however, embodiments of the invention include additional features that attempt to prevent this.

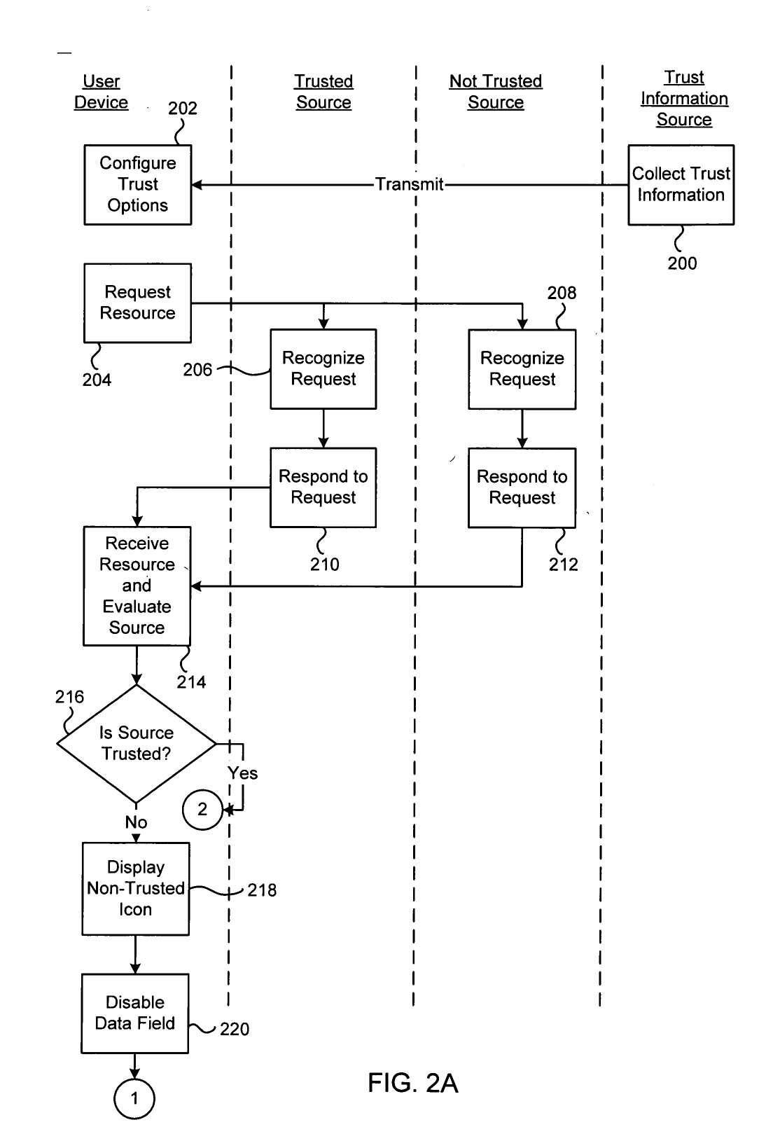

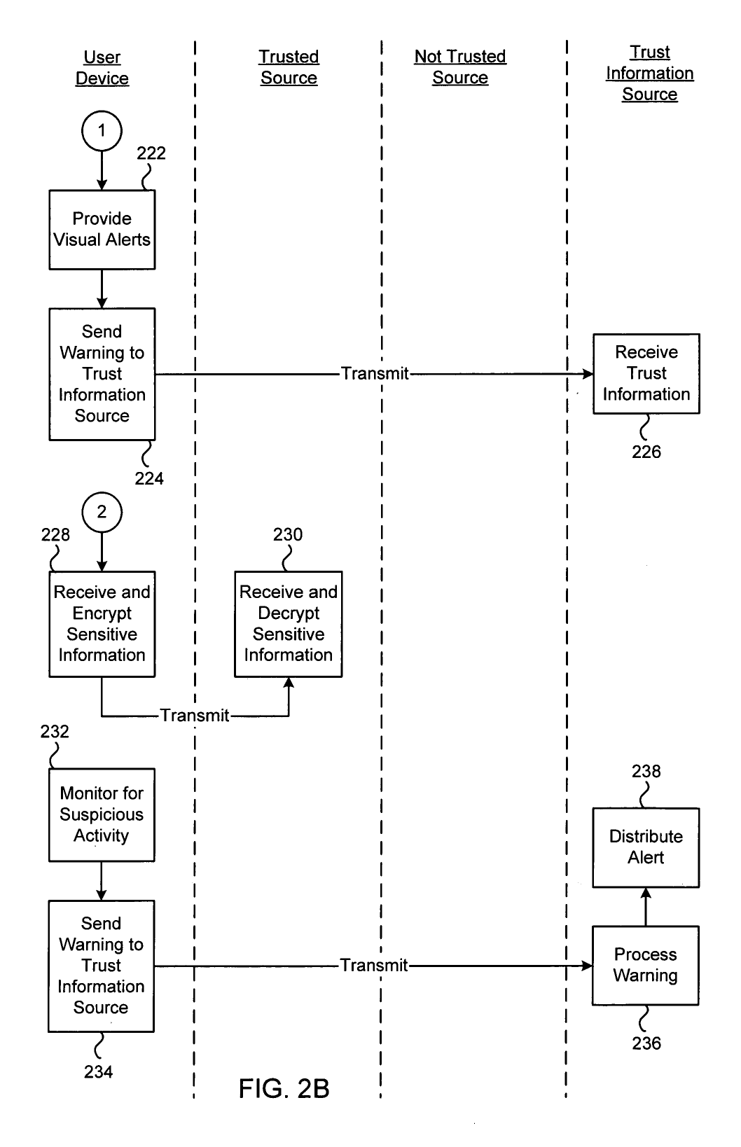

Attention is directed to FIGS. 2A and 2B, which illustrate a swim diagram depicting the interaction among a user device, a trusted source, an untrusted source, and a trust information source according to embodiments of the invention. The methods depicted by this swim diagram may be implemented in the network system 100 of FIG. 1. It should be understood by those skilled in the art that the steps and operations described herein are not necessarily essential. Other methods in other embodiments may include more, fewer, or different steps and operations than those described herein. Further, the steps and operations may occur in orders different than shown here. This, the steps and operations depicted here are merely one specific embodiment.

At operation 200, a trust information source (such as trust authority 110) collects trust information from users, other trust authorities, independent monitoring, and the like. In some cases the information is evaluated, and false reports and the like are disregarded. Periodically, however, the information is distributed to users. The information may include known trusted sources, and known untrusted sources. In ways known to those skilled in the art, the transmission may be cryptographically signed with a public key that chains up to an embedded trusted CA in the security application so that the user has confidence that the information may be relied upon. The trusted list may include domain names, fully qualified domain names, Uniform Resource Identifiers (“URIs,” such as URLs), and the like.

The information, or trusted site list, may be sent periodically from the trust information source 110 to user devices on a predetermined schedule. Alternatively, or additionally, the trust information source may be polled by users. The trust source may have an address, such as a URL, embedded in a digitally signed certificate that chains up to a trusted Root CA certificate in the security application.

Thus, a user may, at block 202, configure his trust options. The user may chose to include all or only certain parts of the information provided by the trust information source. Additionally, the user may include or exclude specific sites known to the user to be trusted or untrusted. The user also may chose to include information from an organization within which the user operates. Many other examples are possible and apparent to those skilled in the art. Modification may require user authentication, which may be once per session, once per application instance, and the like.

At block 204, the user sends a request for a resource. As those skilled in the art appreciate, this may involve typing a URL into an address window of a browser, selecting a stored “favorites” link, selecting a hyperlink in a web page, and the like. In some such examples, the link is to an untrusted source. In others, the link is to a trusted source, but the request is “sensed” by an untrusted source. Thus, a blocks 206 and 208 both a trusted source and an untrusted source, respectively, recognize the resource request and both attempt to respond to it a blocks 210 and 212. The untrusted source's response, however, is an attempt to imitate the trusted sources response so as to fool the user into providing sensitive information to the untrusted source.

At block 214, the user device receives either or both of the resources from the trusted and untrusted sources. If only one resource is received, the remaining decisioning may be made based only on the single resource. If more than one is received, however, the decisioning may be made on the current “focused” resource. Those skilled in the art understand how the control regions of browsers or other applications may change appearance depending upon which of several windows within the environment has the current “focus.” This applies here. Thus, the resource of the untrusted site may overlay the trusted site so that the user has difficulty identifying its presence. In order for the user to enter data into the resource, however, the focus would have to be on that resource, and the security application described herein can apply the teachings herein to appropriately alert the user.

At block 216, the security application decides whether the resource is from a trusted source. In some embodiments, the application consults a trusted sites list, an untrusted sites list, a user-configured option, and/or the like to decide. If the source is trusted, the process continues at reference number 2 in FIG. 2B as will be described. If the source is not trusted, the process continues at block 218.

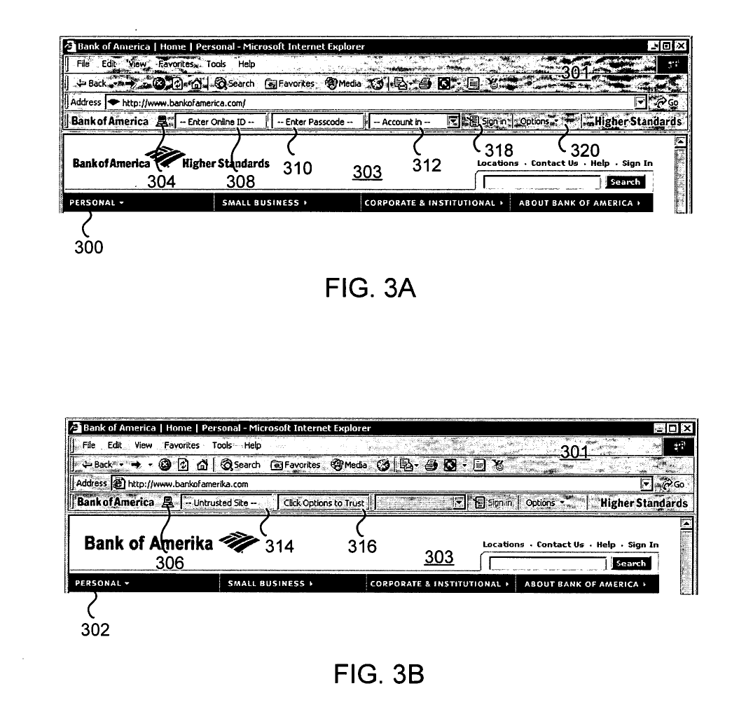

At block 218, the application displays an untrusted site icon. Thus, attention is briefly directed to FIGS. 3A and 3B, which illustrate embodiments of browser windows displaying resources (i.e., web pages) from trusted and untrusted sources respectively. FIG. 3A depicts a browser window 300 associated with a trusted site, while FIG. 3B depicts a browser window 302 associated with an untrusted site. Each include a control region 301 and a display region 303. In FIG. 3A, a trust icon 304 has one appearance for a trusted site. FIG. 3B depicts the trust icon's 306 appearance for an untrusted site. Thos skilled in the art will appreciate that the icon's appearance may change in any of a number of ways. For example, the icon may be a specific color, green for example, when a source is trusted, and red when a source is untrusted. The icon may be larger in one case and smaller in the other Many other examples are possible.

In some embodiments, a visual cue to the user includes a graphic or text representation of the level of trust of the resource. The trust level may be a number on a scale or a color from a spectrum. The trust level may be calculated based on any of a number of factors, some of which may be configured by the user. In some embodiments, the trust level might be specifically configured for known sites in advance. Or factors such as the domain of the site might be applied. For example, a specific known site in the domain (e.g. dev.arcot.com) might be given the highest trust level, while other sites in the domain (e.g. sales.arcot.com) might still be trusted, but not to the same level. Similarly, a well-known site where the user has an existing relationship might engender the highest trust; sites known to be reputable businesses might be trusted somewhat but not completely; completely unknown sites, not at all. Negative configurations are also possible, either set up by the user or the trust information source—that is, sites identified as specifically not trustworthy, e.g. known attacker sites. Many other examples are possible and apparent to those skilled in the art in light of this disclosure.

Returning to FIG. 2A in combination with FIGS. 3A and 3B, the process continues at block 220. At block 220, a data field is specifically configured depending on whether the source is trusted or untrusted. For example, in FIG. 3A, the data field 308 is available to accept the user's Online ID, whereas the same data field 314 of FIG. 3B is “grayed out,” and cannot accept input. In some examples, the data field may be hidden and unhidden depending on the trust status. Additionally, the data field 314 includes the text “untrusted site” to further alert the user that the source is untrusted. Thus, the presence or absence of the data field and/or the state of the icon serve to alert the user to the status of the source. Through repetitive use, users are conditioned to attempt to enter sensitive information into the tool bar, or other appropriate location, depending upon the embodiment of the security application (e.g., a dialog box in a standalone application, or the like). When the user encounters a situation wherein the user cannot enter information because the data field is grayed out, the user is alerted that the source is untrusted.

In some embodiments, the data field 308 is available only if the resource has a certificate containing a public encryption key signed by a CA (either directly or through a chain) appearing on a Root Certificate in the security application. In some embodiments, this requirement is combined with a requirement that an identifier of the resource (domain name, URL, or the like) match some information in the certificate, such as the common name. Other checks may include SSL and certificate validation. In some embodiments, a bitmap of an authorized organization may be included in the certificate and presented as part of the interface.

The process continues at reference numeral 1 in FIG. 2B and block 222. At block 222, the security application provides additional visual alerts to the user. In some embodiments, this comprises providing a particular background color around a data field, randomly generating a particular color, providing a border color, and providing a “personal assurance message” to the user. A personal assurance message (PAM) may be any predefined, user-configured word, phrase, symbol, and/or the like. The PAM may appear in the data field when the source of a resource is trusted and not appear when the source is not trusted. Thus, a user may become conditioned to only provide sensitive information into data fields when the user sees his PAM. The PAM may be configured at installation in response to a specific question (e.g., what's your favorite pet's name?), a general question (what would you like your PAM to be?), or a selection from a list. Many other examples are possible and apparent to those skilled in the art in light of this disclosure.

The process may continue at block 224. At block 224, the security application may assemble a warning to a trust authority regarding having encountered an untrusted site. The warning is transmitted then, at block 226, received by the trust authority. The trust authority may process the warning and/or distribute an alert associated with the warning as will be described further hereinafter. In other embodiments, the user may initiate a warning by, for example, selecting a button on the interface.

Returning to reference numeral 2 and block 228, the sequence of operations related to determining a source to be trusted will be described. At block 228, having determined a source to be trusted, the security application receives sensitive information. Thus, in a specific example, the data field 308 of FIG. 3A is available for receiving user input, as may be the data field 310, and/or 312. In some embodiments, the security application is specifically configured to interact with trusted sources and display specific data fields to the user, in some cases sequentially after transmitting the input to the trusted source. Thus, a user may first enter an account number, then be prompted, via a subsequent data field, to enter his pass code, and so on. In each case, the user may also see his PAM, thus providing further assurance that the input continues to be directed to the trusted source.

In some embodiments, the security application uses an organization's public key that must be signed and chained to a trusted CA to encrypt the user's sensitive information. This provides even greater protection for the user's sensitive information.

At block 230, the trusted source receives the transmission from the user. If necessary, the source uses its private key to decrypt the transmission.

Block 232 begins another process wherein the security application continues to monitor activities on the user's device for suspicious activity. Examples include too many browsers and children, creation or destruction happening too rapidly, focus changing too rapidly, on-topness changing too rapidly, and the like. The types of suspicious activity may be user configured. If suspicious activity is detected, the user may be alerted via the icons and other visual warnings, depending upon the type of activity detected and the user's pre-selected response to such activity.

Additionally, the security application may assemble a warning to be sent to a trust authority. The warning may include information that identifies a source that caused or was “present” during the suspicious activity. Upon receipt at block 236, the trust authority may process the warning to verify the information and determine whether the warning is false. If the warning is legitimate, the trust authority may distribute an alert to other users at block 238. Thus, through a central authority, threats may be quickly evaluated and information concerning threats may be rapidly broadcast to other users.

Attention is redirected to FIG. 3A. The security application embodied in the tool bar of FIG. 3A includes two additional items not previously discussed: a “sign in” icon 318 and an options drop down menu 320. The options menu 320 may be used to configure the security to work as the user desires. For example, the options menu may allow the user to, for example: set trust levels; determine trust authorities from whom trust information will be accepted; configure the receipt of trust information from organizational authorities; select trusted certificate authorities; set PAMs; and the like. In light of this disclosure, those skilled in the art will appreciate may other such options that may be configured. In some embodiments, the user must “sign in” using, for example, the sign in icon 318 prior to setting or changing options. This may include entering a user name and pre-selected password. Other examples are possible.

Having described several embodiments, it will be recognized by those of skill in the art that various modifications, alternative constructions, and equivalents may be used without departing from the spirit and scope of the invention. Additionally, a number of well known processes and elements have not been described in order to avoid unnecessarily obscuring the present invention. For example, those skilled in the art know how to arrange computers into a network and enable communication among the computers. Additionally, those skilled in the art will realize that the present invention is not limited to tool bars, plug ins, or applications embedded within browser applications. For example, embodiments of the invention may be standalone applications. Accordingly, the above description should not be taken as limiting the scope of the invention, which is defined in the following claims.

1. A user interface through which a user at a client device interacts, via a network, with one or more resource sources, the user interface comprising:
a display window that displays resources sent to the client device from the one or more resource sources; and
a control area having one or more applications that allow the user to manipulate interaction with the one or more resource sources, wherein the one or more applications comprise a security application that includes:
a) at least one data field for receiving input from the user to be sent to a specific resource source; and
b) an icon that provides a visual indication of whether the specific source is a trusted resource source.

2. The user interface of claim 1, wherein the user interface further includes means for interacting with a source of information relating to whether resource sources are trusted resource sources.

3. The user interface of claim 1, wherein the user interface comprises a web browser.

4. The user interface of claim 3, wherein the security application comprises a plug-in to the web browser.

5. The user interface of claim 1, wherein the client device comprises a selection from the group consisting of personal computer, personal digital assistant, laptop computer, workstation, and cell phone.

6. The user interface of claim 1, wherein the one or more resource sources comprise web sites.

7. The user interface of claim 1, wherein the at least one data field has at least two states, a first state that accepts input if the specific resource source is a trusted resource source, and a second state that does not accept input if the specific resource source is not a trusted resource source.

8. The user interface of claim 1, wherein the security application comprises a tool bar.

9. The user interface of claim 1, wherein the security application comprises a dialog box.

10. The user interface of claim 1, wherein the security application comprises a popup window.

11. The user interface of claim 1, wherein the security application comprises a standalone application.

12. The user interface of claim 1, wherein the security application includes an options menu for configuring the security application.

13. The user interface of claim 1, wherein the security application includes a selection that allows the user to declare a specific resource source to be a trusted resource source.

14. The user interface of claim 13, wherein the selection that allows the user to declare a specific resource source to be a trusted resource source requires user authentication.

15. The user interface of claim 1, wherein the security application includes a visual indication of a level of trust of a specific resource source.

16. The user interface of claim 15, wherein the visual indication includes a number from a scale.

17. The user interface of claim 15, wherein the visual indication includes a color from a spectrum.

18. The user interface of claim 1, wherein the data field includes a predetermined, user-defined personal assurance message that signals the user that the security application generated the data field.

19. The user interface of claim 1, wherein the security application further includes a randomly-generated visual background.

20. A method of facilitating interaction between a user at a client device and a resource source, wherein the client device includes a user interface through which the user interacts, via a network, with one or more resource sources, the method comprising:
evaluating whether a resource directed to the client device is from a trusted resource source;
displaying an icon on the client device that provides a visual indication of whether the resource is from a trusted resource source; and
providing, in a control area of the client device, a data field for receiving input from the user to be sent to the resource source, wherein the icon and data field together comprise a security application.

21. The method of claim 20, further comprising receiving from a source of information an indication of whether one or more resource sources are trusted resource sources.

22. The method of claim 20, wherein the user interface comprises a web browser.

23. The method of claim 20, wherein the client device comprises a selection from the group consisting of personal computer, personal digital assistant, laptop computer, workstation, and cell phone.

24. The method of claim 20, wherein the one or more resource sources comprise web sites.

25. The method of claim 20, wherein providing a data field comprises:
providing the data field in a first state that accepts input if the resource source is a trusted resource source; and
providing the data field in a second state that does not accept input if the resource source is not a trusted resource source.

26. The method of claim 20, wherein the security application comprises a tool bar.

27. The method of claim 20, wherein the security application comprises a dialog box.

28. The method of claim 20, wherein the security application comprises a popup window.

29. The method of claim 20, further comprising providing an options menu for configuring the security application.

30. The method of claim 20, further comprising receiving a selection from the user declaring a specific resource source to be a trusted resource source.

31. The method of claim 30, further comprising receiving user authentication prior to receiving the selection.

32. The method of claim 20, further comprising providing a visual indication of a level of trust of the resource source.

33. The method of claim 32, wherein the visual indication includes a number from a scale.

34. The method of claim 32, wherein the visual indication includes a color from a spectrum.

35. The method of claim 20, further comprising providing in the data field a predetermined, user-defined personal assurance message that signals the user that the security application generated the data field.

36. The method of claim 20, further comprising providing a randomly-generated visual background to the security application.
